(19) United States
(12) Patent Application Publication
(10) Pub. No.: US 2024/0182994 A1
(43) Pub. Date: Jun. 6, 2024

(54) METHOD FOR MANUFACTURING REFERENCE PIECE FOR MEASURING RETAINED AUSTENITE

(71) Applicant: SINTOKOGIO, LTD., Nagoya-shi (JP)

(72) Inventors: Yuta Saito, Nagoya-shi (JP); Atsuki Kurokawa, Nagoya-shi (JP); Kan Aoki, Nagoya-shi (JP)

(73) Assignee: SINTOKOGIO, LTD., Nagoya-shi (JP)

(21) Appl. No.: 18/526,078

(22) Filed: Dec. 1, 2023

(30) Foreign Application Priority Data
Dec. 6, 2022 (JP) 2022-194778

(51) Int. Cl. C21D 8/00; C21D 1/18; C21D 6/00; C22C 38/00; C22C 38/02; C22C 38/04; C22C 38/42; C22C 38/44; C22C 38/46

(52) U.S. Cl. CPC C21D 8/005; C21D 1/18; C21D 6/004; C21D 6/005; C21D 6/008; C22C 38/002; C22C 38/02; C22C 38/04; C22C 38/42; C22C 38/44; C22C 38/46; C21D 2201/00; C21D 2211/001

(57) ABSTRACT

The manufacturing method of the reference piece for measuring retained austenite includes performing quenching and tempering a metal member after performing nano-crystallization on at least a portion of a surface of the metal member.

### CROSS-REFERENCE TO RELATED APPLICATION

This application is based on Japanese Patent Application No. 2022-194778 filed with Japan Patent Office on Dec. 6, 2022, the entire contents of which are hereby incorporated by reference.

### TECHNICAL FIELD

The present disclosure relates to a manufacturing method of a reference piece for measuring retained austenite.

### BACKGROUND

Japanese Patent Application Publication No. 2020-041830 discloses a reference piece used for calibration or adjustment of an apparatus for measuring stress using X-rays.

### SUMMARY

In some cases, retained austenite of an object to be measured is measured using X-rays. Austenite is a metal crystal having a face-centered cubic (FCC) structure. When the steel is quenched, that is, when the steel is rapidly cooled after the temperature of the γ region is maintained, transformation into a body-centered cubic (BCC) structure martensite may not be performed, and austenite may remain in the metal. Retained austenite refers to what remains as this partially untransformed austenite. Retained austenite causes problems such as a decrease in hardness and a change in product dimensions, however, has an effect of improving toughness and preventing a phenomenon such as cracking or quenching cracking during use. Therefore, it is required to more accurately measure the retained austenite of the measurement object.

However, it is difficult to prepare a reference piece for measurement because there is a possibility that the retained austenite is transformed into martensite due to impact or the lapse of time. The present disclosure provides a technique for manufacturing a reference piece for measuring retained austenite that is less prone to measurement variations.

A manufacturing method of a reference piece for measuring retained austenite according to an aspect of the present disclosure includes performing quenching and tempering a metal member after performing nano-crystallization on at least a portion of a surface of the metal member.

According to the present disclosure, it is possible to manufacture a reference piece for measuring retained austenite which is a bulk body and in which variation in measurement is less likely to occur.

### BRIEF DESCRIPTION OF THE DRAWINGS

FIG. 1 is a flowchart illustrating a manufacturing method of an X-ray reference piece for measuring retained austenite according to an embodiment.

FIG. 2 is a graph showing the relationship between the carbon content of a metal member and the retained austenite amount of after quenching.

FIG. 3 is a graph showing the relationship between time and temperature in the heat treatment step.

FIGS. 4A and 4B are conceptual diagrams showing an X-ray retained austenite measurement result.

FIG. 5 is a graph showing the relationship between the number of measurements and the volume ratio of retained austenite.

FIG. 6 is a graph showing the relationship between elapsed days and the volume ratio of retained austenite.

### DETAILED DESCRIPTION

### Summary of Embodiments of the Present Disclosure

First, an outline of an embodiment of the present disclosure will be described.

(Clause 1) A manufacturing method of a stress measurement reference piece according to an aspect of the present disclosure, includes performing nano-crystallization on at least a portion of a surface of a metal member, and then performing quenching and tempering the metal.

In the manufacturing method according to the clause 1, for example, orientation of the metal member is cancelled by performing nano-crystallization on at least a part of the surface of the metal member. That is, the orientations of the metal crystal planes oriented in the same direction generated by the manufacturing process are dispersed. Thereafter, quenching and tempering are performed. Quenching is a process of heating a metal member and then rapidly cooling the metal member to harden the metal member. Tempering is a process of applying heat to the quenched metal member to decrease hardness and increase toughness. The retained austenite is stabilized by quenching and tempering the metal member in which the orientation has been cancelled. That is, a reference piece capable of obtaining a diffraction profile having no deviation in peak intensity without depending on the processing history of the material is manufactured. Therefore, according to the manufacturing method of the clause 1, it is possible to manufacture a reference piece for measuring retained austenite which is a bulk body and in which variation in measurement is less likely to occur.

(Clause 2) In the manufacturing method described in clause 1, the nano-crystallization may be performed by shot peening.

(Clause 3) In the manufacturing method described in clause 2, the orientation of the metal member may be canceled by shot peening.

(Clause 4) In the manufacturing method according to clause 2 or 3, shot peening may cause the metal member to retain crystal grains enough to withstand measurement of residual stress by X-rays.

(Clause 5) In the manufacturing method according to any one of clause 1 to 4, the metal member may be formed of an alloy having iron as a main component.

### EXAMPLES OF EMBODIMENTS OF THE PRESENT DISCLOSURE

Embodiments of the present disclosure will be described in detail with reference to the drawings. In the description of the drawings, the same elements are denoted by the same reference numerals, and redundant description is omitted. The dimensional ratios in the drawings are not necessarily consistent with those in the description. The terms “up”, “down”, “left” and “right” are based on the illustrated state and are for convenience.

### [Manufacturing Method of Reference Piece for Measuring Retained Austenite]

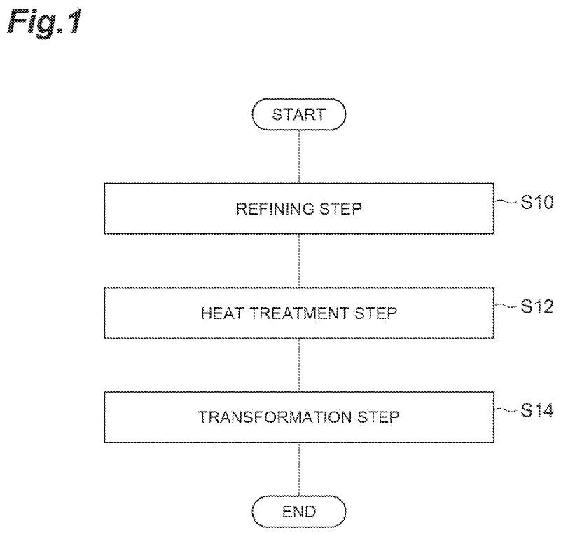

FIG. 1 is a flowchart illustrating a manufacturing method of a reference piece for measuring retained austenite according to an embodiment. As shown in FIG. 1, a manufacturing method M1 includes a refining step (step s10), a heat treatment step (step s12), and a transformation step (step s14).

In the refining step (step S10), nano-crystallization is performed on at least a portion of the surface of the metal member. The metal member is, for example, a bulk metal piece and is formed of an alloy including iron as a main component. The metal member may have a carbon content of 1.0 wt % or more and 7.7 wt % or less, a contained manganese amount of 0.2 wt % or more and 13 wt % or less, and a nickel content of 0.1 wt % or more and 5 wt % or less. When the carbon content of the metal member is 1.0 wt % or more, a bulk body in which the retained austenite amount is 10% or more may be manufactured. When the carbon content of the metal member is increased, a pearlite transformation occurs at a carbon content of 7.7 wt %, and hypoeutectoid steel is transformed into hypereutectoid steel. In the hypereutectoid steel, carbon is precipitated as a simple substance, and γ region transformation point temperature is significantly increased. Therefore, by setting the carbon content of the metal member to 7.7 wt % or less, a bulk body having a retained austenite amount of 10% or more can be stably manufactured. Manganese and nickel are elements that stabilize the retained austenite amount. The contained manganese amount and nickel content are determined by using a Sheafflar diagram in which the vertical axis represents Ni equivalent (% Ni+30×% C+0.5×% Mn) and the horizontal axis represents Cr equivalent (% Cr+% Mo+1.5×% Si+0.5×% Nb) and which represents the structure and ferrite amount at each composition position. The Ni equivalent needs to exceed at least 20 as a calculated value at which stable austenite is generated, and the contained manganese amount satisfying this condition is 13 wt % or less and the nickel content is 5 wt % or less. As the lower limit values of the contained manganese amount and nickel content, numerical values necessary for a general steel material are adopted.

At least a part of the surface of the metal member may be the entire surface or a part of the surface. As an example, nanocrystals may be present in a range of 0 μm to 50 μm in the depth direction from the metal member surface. When nanocrystals are present in a range of 0 μm to 50 μm in the depth direction from the metal member surface, even if recrystallization (coarsening of crystals) occurs in a heat treatment step described below, a crystal grain size (moderate particle size) sufficient for measurement of retained austenite amount can be maintained. Nano-crystallization is a process for making the surface of a metal member into a nano-order crystal. The nano-order is, for example, several nm to several tens of nm.

The nano-crystallization is performed using, for example, shot peening, an equal-channel angular pressing (ECAP) method, or a high-pressure torsion (HPT) method. In the case of nano-crystallization by shot peening, the orientation of the metal member is cancelled, and even if crystallization conditions in the heat treatment step (step S12 described later) are satisfied, crystal grains sufficient to withstand measurement of residual stress by X-rays can be left in the metal member. Note that burnishing is another method for canceling the orientation of the metal member.

As the conditions of shot peening, the hardness or particle diameter of the projection material and the projection speed are determined according to the type of metal member. For example, the hardness of the projection material is appropriately determined from the range of Vickers hardness (JIS Z 2244) of HV400 to HV1200 (preferably HV700 to HV1200) and a particle size number (JIS R 6001) of 20 to 220 (preferably 30 to 100). The JIS is a Japanese industrial standard. For example, when the projection material is projected (ejected) using a pneumatic accelerator, the projection speed is appropriately determined by setting the projection pressure in the range of 0.05 MPa to 1.0 MPa (preferably 0.1 MPa to 0.5 MPa).

The conditions of shot peening are determined so that crystal grains sufficient to withstand the measurement of residual stress by X-rays remain in the reference piece. To withstand the measurement means that a certain number of crystal grains for obtaining reliability in the measurement result of residual stress by X-rays exist within the measurement range.

In a metal piece, the orientations of metal crystal planes tend to be oriented in the same direction in a manufacturing process. Due to the refining step (step S10), the surface of the metallic piece is recrystallized and minimized, and the orientations of the metallic crystal planes oriented in the same direction are dispersed. This ensures non-orienting, which is a requirement for a reference piece used for X-ray measurement.

The heat treatment step (step S12) is then performed. In the heat treatment step (step S12), quenching and tempering take place. Quenching is a process of heating a metal member and then rapidly cooling the metal member to harden the metal member. Tempering is a process of applying heat to the quenched metal member to decrease hardness and increase toughness. For example, the quenching is performed at a heating temperature in the range of 850° C. to 1100° C. and a processing time in the range of 30 minutes to 120 minutes. The tempering is performed at a heating temperature in a range of 180° C. to 650° C. and a processing time in a range of 30 minutes to 90 minutes. As a result, the crystal grains of the metal piece are uniformized, the distortion is removed, and the retained austenite of the metal piece is uniformly dispersed and stabilized. That is, a reference piece for measuring retained austenite in which variation in measurement is less likely to occur is obtained.

Finally, as the transformation step (step S14), a step of making a state in which variation in measurement is less likely to occur is performed. For example, the ratio between martensite and austenite is adjusted by shot peening. As a more specific example, austenite may be changed into martensite by shot peening. The transformation step (step S14) may be omitted depending on the performance required for the reference piece.

By executing the flowchart shown in FIG. 1, a reference piece for measuring retained austenite in which the retained austenite amount is 1% or more and 30% or less can be obtained.

### SUMMARY OF EMBODIMENT

The reference piece is used in an X-ray measuring device, for example to measure the volume ratio of the austenite amount. More specifically, the ratio of the FCC structure (austenite) and the BCC structure (martensite) present in the X-ray irradiation range is measured. The ratio is calculated from integrated intensities of a diffraction peak 128.8 deg (FCC structure) and a diffraction peak 156.4 deg (BCC structure). Therefore, on the surface of the reference piece, the mixed state of crystal grains must be uniform everywhere.

According to the manufacturing method M1 of the present embodiment, since the crystallinity of the reference piece is made uniform, the reference piece that does not depend on the processing history of the material and can obtain a diffraction profile in which the peak intensity is not biased over the entire a diffraction ring 360 degree is manufactured. Therefore, according to the manufacturing method M1, the mixed state of crystal grains is uniformized, and a stable reference piece for measuring retained austenite in which variation in measurement is less likely to occur is obtained.

While various exemplary embodiments have been described above, various omissions, substitutions, and changes may be made without being limited to the exemplary embodiments described above.

### EXAMPLE

Hereinafter, an embodiment carried out by the present inventor will be described to explain the above-described effect.

### (Carbon Content of Metal Member)

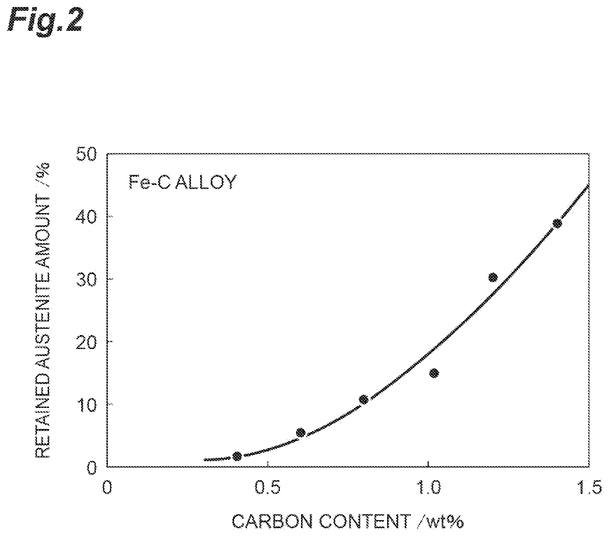

To determine the carbon content of the metal member, a plurality of metal members having different carbon contents were prepared. The prepared metal member is Fe—C alloy which is a steel material, and carbon contents thereof are 0.4 wt %, 0.6 wt %, 0.8 wt %, 1.0 wt %, 1.2 wt %, and 1.4 wt %, respectively. These metal members were subjected to quenching, and then the retained austenite amount was measured. The measurement result is shown in FIG. 2. FIG. 2 is a graph showing the relationship between the carbon content of a metal member and the retained austenite amount of after quenching. As shown in FIG. 2, the retained austenite amount was 1% for a metal member having a carbon content of 0.4 wt %, 5% for a metal member having a carbon content of 0.6 wt %, 11% for a metal member having a carbon content of 0.8 wt %, 15% for a metal member having a carbon content of 1.0 wt %, 30% for a metal member having a carbon content of 1.2 wt %, and 40% for a metal member having a carbon content of 1.4 wt %. Therefore, it was confirmed that when a bulk body having a retained austenite amount of 10% or more is manufactured, the carbon content of the metal member needs to satisfy 0.8 wt % or more, and to stably manufacture the bulk body, the carbon content needs to satisfy 1.0 wt % or more.

### (Manufacture of Reference Piece)

As the metal member, a metal piece formed of SKD11 and having a size of 20 mm×20 mm×10 mm was prepared. The composition is 1.48 wt % carbon (C), 0.28 wt % silicon (Si), 0.4 wt % manganese (Mn), 0.022 wt % phosphorus (P), 0.001 wt % sulfur (S), 0.08 wt % copper (Cu), 0.17 wt % nickel (Ni), 11.55 wt % chromium (Cr), 0.86 wt % molybdenum (Mo), and 0.21 wt % vanadium (V).

The metal member was processed according to the flow chart shown in FIG. 1. The refining step (step S10) shot peening conditions were set such that shot was steel, particle size was 0.05 mm, projection pressure was 0.2 MPa, and coverage exceeded 200%.

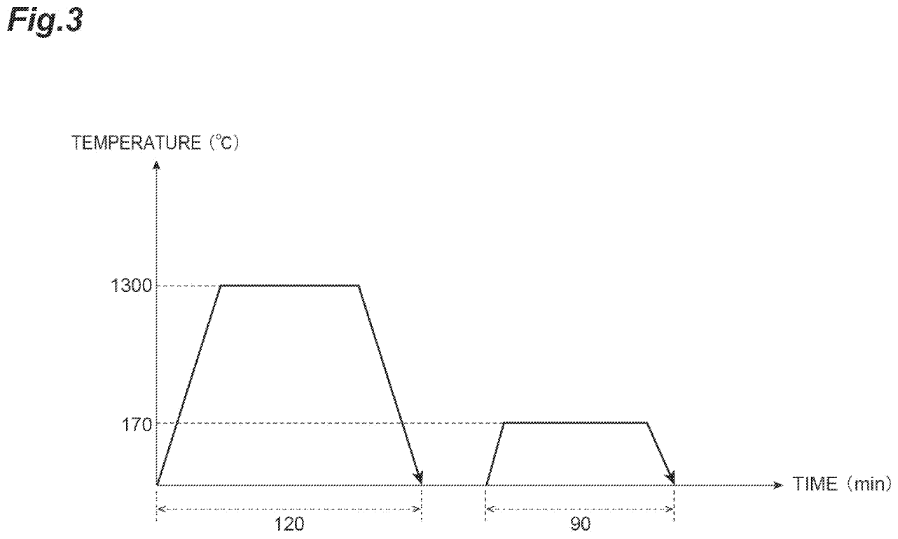

The heat treatment step (step S12) was treated at the temperatures and times shown in FIG. 3. FIG. 3 is a graph showing the relationship between time and temperature in the heat treatment step. As shown in FIG. 3, two stages of heat treatment are performed according to time. The first stage heat treatment is quenching, and the second stage heat treatment is tempering. Here, a series of processes of heating the metal to 1300° C., holding it, and rapidly cooling it was performed in 120 minutes. Thereafter, a series of processes of heating the metal to 170° C., holding it, and cooling it was carried out in 90 minutes.

Finally, the transformation step (step S14) was performed. The shot peening conditions were set such that shot was alundum, particle size was 1 μm, projection pressure was 0.4 MPa, and coverage exceeded 200%.

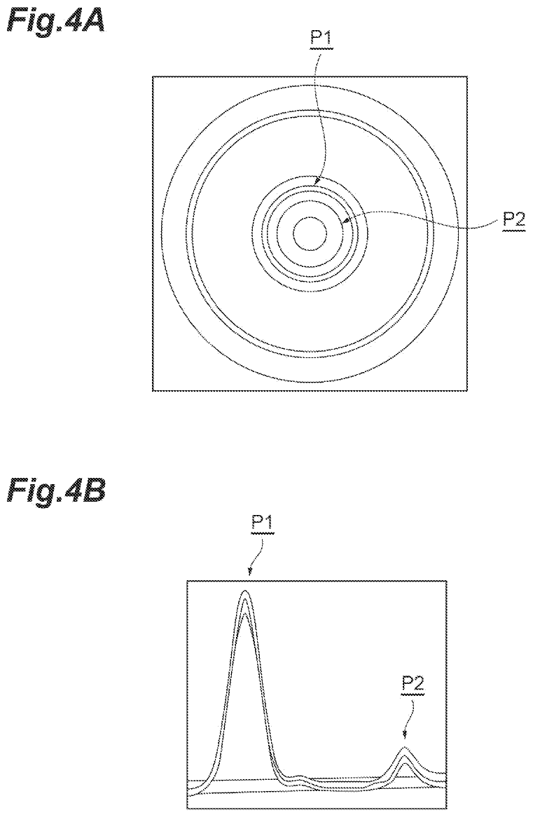

The obtained reference piece was measured by an X-ray measuring apparatus. The results are shown in FIGS. 4A and 4B. FIGS. 4A and 4B are conceptual diagrams showing an X-ray retained austenite measurement result, and is a diagram of an actual profile. FIG. 4A shows a Debye Scherrer ring, and FIG. 4B is a partial cross-sectional view of FIG. 4A. The first peak P1 shown in FIGS. 4A and 4B is ferrite or martensite, and is an X-ray diffraction measurement result of the α 211 plane. The second peak P2 is austenite and is an X-ray diffraction measurement result of the γ 220 plane. From the peak intensity ratio, a volume ratio γ of retained austenite was about 11%. In addition, it was confirmed that a large error did not occur over the entire region of 360 degrees and the mixed state of crystal grains was uniform.

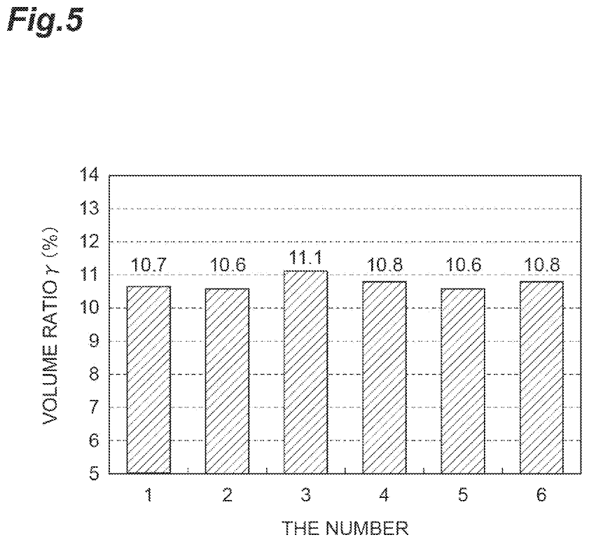

Further, to confirm that the FCC structure and the BCC structure are uniformly mixed, the relationship between the number of measurements and the volume ratio of retained austenite was confirmed. FIG. 5 is a graph showing the relationship between the number of measurements and the volume ratio of retained austenite. The horizontal axis is the number of measurements and the vertical axis is the volume ratio γ of the retained austenite. As shown in FIG. 5, even if the number of measurements changes, the value of γ only changes in the range of 10.6% to 11.1%, and it was confirmed that the value of γ is very stable. As described above, it was confirmed that the FCC structure and the BCC structure were uniformly mixed.

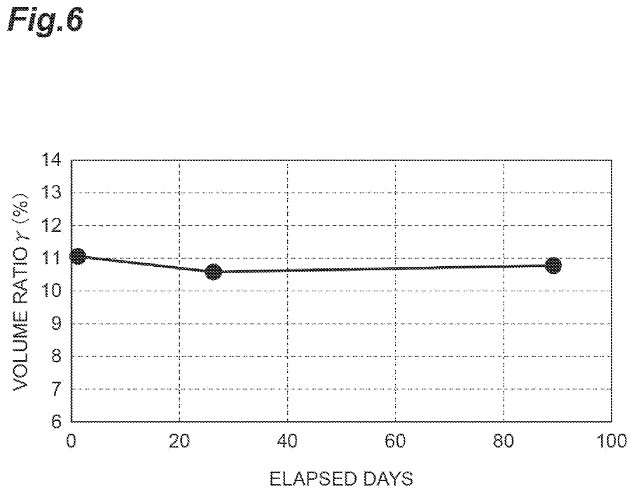

Further, to investigate the stability of the retained austenite, the temporal change of the volume ratio of the retained austenite was investigated. FIG. 6 is a graph showing the relationship between elapsed days and the volume ratio of retained austenite. Measurements were made up to 90 days from machining completion date. As shown in FIG. 6, it was confirmed that there was a change in the range of 10.5% to 11%, and there was only a change within an error range by measurement. That is, it was confirmed that the reference piece was stable and resistant to temporal change.

What is claimed is:

1. A method of manufacturing a reference piece for measuring retained austenite, the method comprising performing quenching and tempering a metal member after performing nano-crystallization on at least a portion of a surface of the metal member.

2. The method according to claim 1, wherein the nano-crystallization is performed by shot peening.

3. The method according to claim 2, wherein an orientation of the metal member is cancelled by the shot peening.

4. The method according to claim 2, wherein crystal grains sufficient to withstand measurement of residual stress by X-ray are left in the metal member by the shot peening.

5. The method according to claim 2, wherein the metal member is formed of an alloy having iron as a main component.
